(19) United States
(12) Patent Application Publication
(10) Pub. No.: US 2025/0044543 A1
(43) Pub. Date: Feb. 6, 2025

(54) PERISCOPIC IMAGE CAPTURING DEVICE AND FOCUSING LENS ASSEMBLY THEREOF

(71) Applicant: GUANGZHOU LUXVISIONS INNOVATION TECHNOLOGY LIMITED, Guangzhou (CN)

(72) Inventors: Jyun-Jie Lin, Guangzhou (CN); Tsung-Kai Chang, Guangzhou (CN); Chuan-Hui Liu, Guangzhou (CN)

(73) Assignee: GUANGZHOU LUXVISIONS INNOVATION TECHNOLOGY LIMITED, Guangzhou (CN)

(21) Appl. No.: 18/618,224

(22) Filed: Mar. 27, 2024

(30) Foreign Application Priority Data
Aug. 4, 2023 (CN) 202310981145.3

(51) Int. Cl. G02B 7/08; G02B 3/14; G02B 23/08

(52) U.S. Cl. CPC G02B 7/08; G02B 3/14; G02B 23/08

(57) ABSTRACT

A focusing lens assembly includes a housing, a liquid lens, a solid lens assembly, an elastic member set, and a driving assembly. The liquid lens covers a light incidence port of the housing and includes an operating member. The solid lens assembly is located in an accommodating space of the housing. A liquid lens optical axis substantially coincides with the solid lens optical axis. The elastic member set is configured to suspend the solid lens assembly in the accommodating space. The driving assembly includes a coil set fixed to the solid lens assembly and a fixed magnet set fixed to the housing and corresponds to the coil set. When the coil set is driven, the coil set interacts with the fixed magnet set, so that the solid lens assembly moves along the solid lens optical axis to selectively enable the solid lens assembly to abut against the operating member.

### CROSS-REFERENCE TO RELATED APPLICATION

This non-provisional application claims priority under 35 U.S.C. § 119 (a) to patent application No. 202310981145.3 filed in China on Aug. 4, 2023, the entire contents of which are hereby incorporated by reference.

### BACKGROUND

### Technical Field

The present invention relates to a periscopic image capturing device and a focusing lens assembly thereof, and in particular, to a focusing lens assembly with a liquid lens.

### Related Art

Most handheld electronic devices are equipped with a focusing lens assembly to have a photographing function. A focal length of the focusing lens assembly varies depending on the application. Some applications use a long-focus focusing lens assembly, some applications use a short-focus focusing lens assembly, and some applications use long-focus and short-focus focusing lens assemblies. Secondly, the handheld electronic devices continue to develop toward miniaturization and thinness. Therefore, miniaturizing and thinning the focusing lens assembly become a trend.

### SUMMARY

The present invention provides a focusing lens assembly, including a housing, a liquid lens, a solid lens assembly, an elastic member set, and a driving assembly. The housing is provided with an accommodating space. The accommodating space forms a light incidence port in the housing. The liquid lens covers the light incidence port and includes an operating member. The liquid lens has a liquid lens optical axis. The solid lens assembly is located in the accommodating space and has a solid lens optical axis. The liquid lens optical axis substantially coincides with the solid lens optical axis. The elastic member set is configured to suspend the solid lens assembly in the accommodating space. The driving assembly includes a coil set and a fixed magnet set. The coil set is fixed to the solid lens assembly. The fixed magnet set is fixed to the housing and corresponds to the coil set. When the coil set is driven, the coil set interacts with the fixed magnet set, so that the solid lens assembly moves along the solid lens optical axis to selectively enable the solid lens assembly to abut against the operating member.

In some embodiments, the coil set includes two first coils and two second coils. The fixed magnet set includes three first fixed magnets and three second fixed magnets. Each of the first coils is fixed to a first side of the solid lens assembly. Each of the second coils is fixed to a second side of the solid lens assembly. Each of the first fixed magnets is fixed to a first side of the housing. Each of the second fixed magnets is fixed to a second side of the housing. The first coils correspond to the first fixed magnets. The second coils correspond to the second fixed magnets.

In some embodiments, the first fixed magnets are adjacent in sequence. The first coils correspond respectively to adjacent positions of the first fixed magnets. The second fixed magnets are adjacent in sequence. The second coils correspond respectively to adjacent positions of the second fixed magnets.

In some embodiments, the coil set includes three first coils and three second coils. The fixed magnet set includes four first fixed magnets and four second fixed magnets. Each of the first coils is fixed to a first side of a carrier. Each of the second coils is fixed to a second side of the carrier. Each of the first fixed magnets is fixed to a first side of the housing. Each of the second fixed magnets is fixed to a second side of the housing. The first fixed magnets are adjacent in sequence. The first coils correspond respectively to adjacent positions of the first fixed magnets. The second fixed magnets are adjacent in sequence. The second coils correspond respectively to adjacent positions of the second fixed magnets.

In some embodiments, the elastic member set normally has a force to enable the solid lens assembly to abut against the operating member.

In some embodiments, the elastic member set includes a front elastic member and a rear elastic member. A position of the solid lens assembly close to the light incidence port of the housing is a front end. An end of the solid lens assembly opposite the front end is a rear end. The front elastic member is connected between the front end and the housing. The rear elastic member is connected between the rear end and the housing.

In some embodiments, the solid lens assembly includes the carrier, a plurality of lenses, and a cap. The carrier is provided with a channel. The plurality of lenses are fixed to the channel. The driving assembly drives the carrier to move along the solid lens optical axis to selectively enable the cap to abut against the operating member.

In some embodiments, the liquid lens further includes a lens mount, a first film, a second film, and a fluid. The lens mount is provided with a through hole. The first film and the second film are fixed to the lens mount and cover the through hole. The fluid is accommodated among the through hole, the first film, and the second film. The operating member is connected to an other side of the second film facing away from the fluid.

The present invention further provides a periscopic image capturing device, including an optical redirecting component, a focusing lens assembly, and an image sensor. The optical redirecting component includes an incident surface, a reflective surface, and an emergent surface. An imaging light ray is incident from the incident surface and reflected by the reflective surface and then emitted from the emergent surface. The focusing lens assembly includes a housing, a liquid lens, a solid lens assembly, an elastic member set, and a driving assembly. The housing is provided with an accommodating space. The accommodating space forms a light incidence port and a light emergence port in the housing. The liquid lens covers the light incidence port and includes an operating member. The liquid lens corresponds to the emergent surface and has a liquid lens optical axis. The solid lens assembly is located in the accommodating space and has a solid lens optical axis. The liquid lens optical axis and the solid lens optical axis substantially coincide and are substantially perpendicular to the emergent surface. The elastic member set is configured to suspend the solid lens assembly in the accommodating space. The driving assembly includes a coil set and a fixed magnet set. The coil set is fixed to the solid lens assembly. The fixed magnet set is fixed to the housing and corresponds to the coil set. When the coil set is driven, the coil set interacts with the fixed magnet set, so that the solid lens assembly moves along the solid lens optical axis to selectively enable the solid lens assembly to abut against the operating member. The image sensor is located on an outer side of the light emergence port. The solid lens optical axis substantially extends through a central region of a sensing region of the image sensor.

### BRIEF DESCRIPTION OF THE DRAWINGS

FIG. 1 is a three-dimensional view of an embodiment of a focusing lens assembly.

FIG. 2 is a three-dimensional exploded view of FIG. 1.

FIG. 3 is a cross-sectional view of FIG. 1 taken along line 3-3.

FIG. 4 is a cross-sectional view of FIG. 1 taken along line 4-4.

FIG. 5 is a schematic plan view of some embodiments of a driving assembly.

FIG. 6 is a three-dimensional exploded view of some embodiments of a solid lens assembly.

FIG. 7A, FIG. 7B, and FIG. 7C are schematic diagrams showing that a driving assembly drives a solid lens assembly to move along a solid lens optical axis AXₛ.

FIG. 8 is a three-dimensional view of an embodiment of a focusing lens assembly without an upper housing and a liquid lens in FIG. 1.

FIG. 9 is a three-dimensional view of FIG. 8 from another perspective.

FIG. 10 is a cross-sectional view of some embodiments of a focusing lens assembly.

FIG. 11 is a cross-sectional view of some embodiments of a periscopic image capturing device.

### DETAILED DESCRIPTION

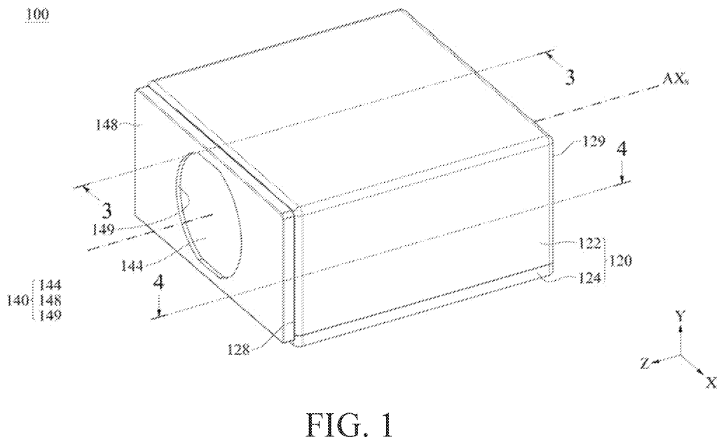

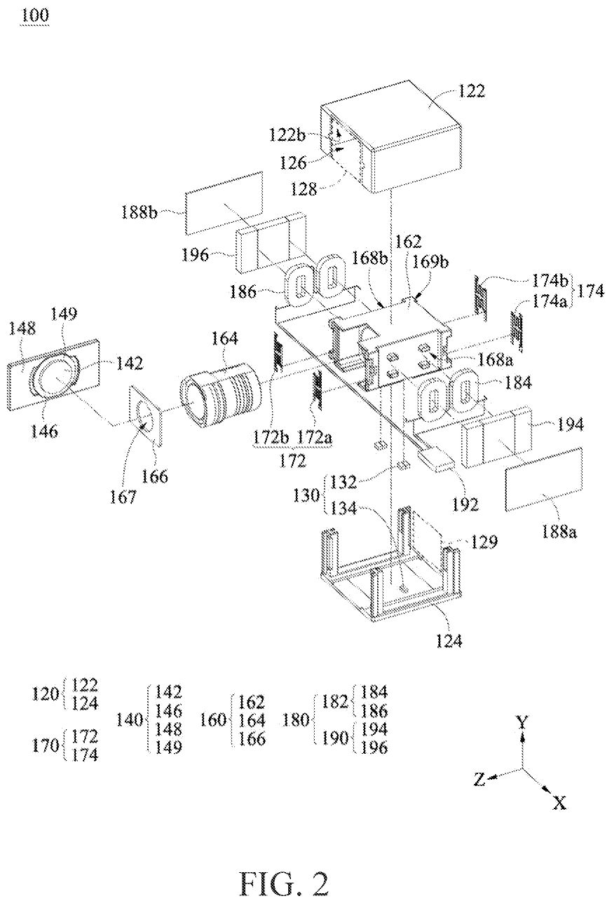

Refer to FIG. 1 to FIG. 2. FIG. 1 is a three-dimensional view of an embodiment of a focusing lens assembly. FIG. 2 is a three-dimensional exploded view of an embodiment of FIG. 1. A focusing lens assembly 100 includes a housing 120, a liquid lens 140, a solid lens assembly 160, an elastic member set 170, and a driving assembly 180.

The housing 120 is provided with an accommodating space 126. The accommodating space 126 forms a light incidence port 128 in the housing 120. The liquid lens 140 covers the light incidence port 128 and includes an operating member 142. The liquid lens 140 has a liquid lens optical axis AXₗ. The solid lens assembly 160 is located in the accommodating space 126 and has a solid lens optical axis AXₛ. The liquid lens optical axis AXₗ substantially coincides with the solid lens optical axis AXₛ. The elastic member set 170 is configured to suspend the solid lens assembly 160 in the accommodating space 126. The driving assembly 180 includes a coil set 182 and a fixed magnet set 190. The coil set 182 is fixed to the solid lens assembly 160. The fixed magnet set 190 is fixed to the housing 120 and corresponds to the coil set 182. When the coil set 182 is driven, the coil set interacts with the fixed magnet set 190 to enable the solid lens assembly 160 to move along the solid lens optical axis AXₛ to selectively enable the solid lens assembly 160 to abut against the operating member 142.

The focusing lens assembly 100 may be applied to any device with zoom demands, for example, a digital camera, a mobile phone, a tablet, a video camera, or a computer. The focusing lens assembly 100 may also be combined with the optical redirecting component to form a periscopic image capturing device (described in detail later), and is applied to the foregoing device with zoom demands.

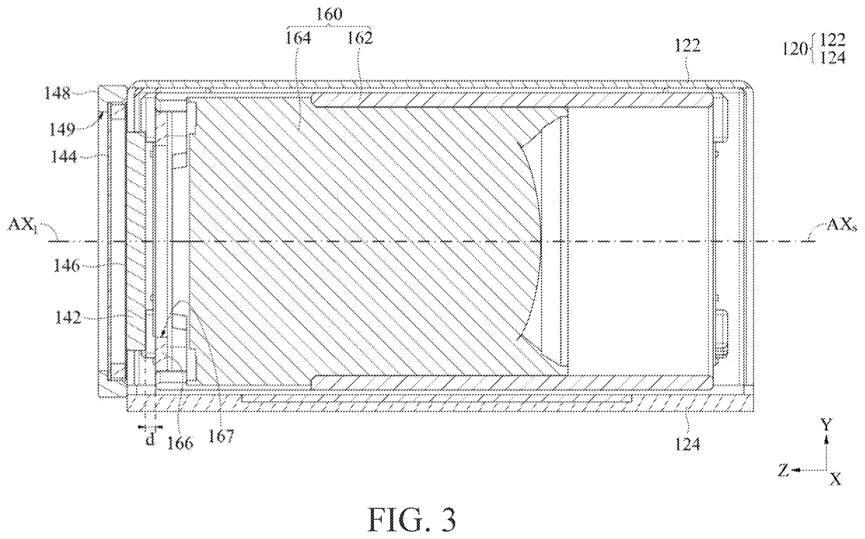

Refer to FIG. 3. FIG. 3 is a cross-sectional view of FIG. 1 taken along line 3-3. A liquid lens optical axis AXₗ substantially coincides with a solid lens optical axis AXₛ. This “substantial coincidence” means that the liquid lens optical axis AXₗ is designed to coincide with the solid lens optical axis AXₛ, but after actual manufacturing and assembly, the liquid lens optical axis AXₗ and the solid lens optical axis AXₛ may not completely coincide, resulting in some errors in alignment of the liquid lens optical axis AXₗ and the solid lens optical axis AXₛ. That is to say, “substantial coincidence” refers to an allowable error in the alignment of the liquid lens optical axis AXₗ and the solid lens optical axis AXₛ. A magnitude of the error depends on an occasion of application of the focusing lens assembly, and the error is allowed to be relatively large in the image sensor 310 or an application that requires less image distortion. On the contrary, the error is allowed to be relatively small.

Secondly, in this embodiment, when the elastic member set 170 suspends the solid lens assembly 160 in the accommodating space 126 and the coil set 182 is not driven, a distance d is defined between the operating member 142 of the liquid lens 140 and the solid lens assembly 160 (that is, a position where the solid lens assembly 160 faces the liquid lens 140 in FIG. 3, the element is a cap 166, which is described in detail later). When the coil set 182 is driven, the solid lens assembly 160 may move along the solid lens optical axis AXₛ (that is, a horizontal axis in FIG. 3) to change a magnitude of the distance d.

Specifically, when the coil set 182 is driven, the solid lens assembly 160 may selectively move along a right side or a left side of the horizontal axis in FIG. 3 (that is, the solid lens optical axis AXₛ, that is, a Z axis in FIG. 3, the Z axis is used for description below). When the solid lens assembly 160 moves along the solid lens optical axis AXₛ, a focal length of the solid lens assembly 160 accordingly changes, to achieve the purpose of adjusting the focal length. In addition, when the solid lens assembly 160 moves in a +Z direction and the foregoing distance d is reduced, the solid lens assembly 160 may contact or even abut against the operating member 142. When the solid lens assembly 160 starts to abut against the operating member 142, the operating member 142 enables a radius of curvature of the liquid lens 140 to change. In this way, the focusing lens assembly 100 has a larger focal length range.

For example, when the solid lens assembly 160 moves from a normal position (a position where the solid lens assembly 160 is suspended and does not contact the operating member 142) in a-Z direction (the horizontal axis to the right in FIG. 3), the focusing lens assembly 100 is adapted to focus an object image at a distance from infinity to 1 meter. When the solid lens assembly 160 moves from the normal position in the −Z direction (the horizontal axis to the left in FIG. 3) and abuts against the operating member 142, the object image position that the focusing lens assembly 100 is adapted to focus is at a distance ranging from 1 meter to 5 centimeters. In this way, a single focusing lens assembly 100 of FIG. 1 can satisfy demands of long-focus and ultra-short-focus applications.

Refer to FIG. 1 again. The housing 120 may a single-piece structure or a multi-piece structure. The housing 120 of the embodiment of FIG. 1 includes an upper housing 122 and a lower housing 124. The upper housing 122 may be fixed to the lower housing 124 to form the foregoing accommodating space 126. The accommodating space 126 is provided with a light incidence port 128 and a light emergence port 129 respectively in the front and rear of the housing 120 (that is, in the +Z and −Z directions in FIG. 1). The light incidence port 128 is configured to let an imaging light ray enter, and the image sensor 310 is located at an appropriate distance from an outer side of the light emergence port 129 (that is, in the −Z direction in FIG. 1).

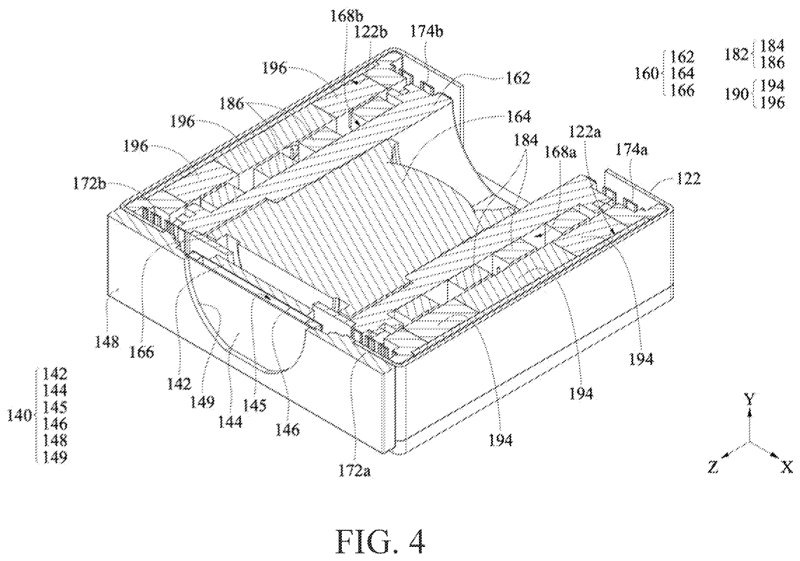

Next, refer to FIG. 2 and FIG. 4 together. FIG. 4 is a cross-sectional view of FIG. 1 taken along line 4-4. In some embodiments, the coil set 182 includes two first coils 184 and two second coils 186. The fixed magnet set 190 includes three first fixed magnets 194 and three second fixed magnets 196. Each of the first coils 184 is fixed to a first side 168a of the solid lens assembly 160. Each of the second coils 186 is fixed to a second side 168b of the solid lens assembly 160. Each of the first fixed magnets 194 is fixed to a first side 122a of the housing 120. Each of the second fixed magnets 196 is fixed to a second side 122b of the housing 120. The first coils 184 correspond to the first fixed magnets 194. The second coils 186 correspond to the second fixed magnets 196.

In some embodiments, the second fixed magnets 196 are adjacent in sequence. The second coils 186 correspond respectively to adjacent positions of the second fixed magnets 196. Specifically, referring to FIG. 2, a center of one of the second coils 186 is roughly aligned with an adjacent position of two corresponding second fixed magnets 196, that is, a position that is indicated by a center line between the second coil 186 and the second fixed magnet 196 in FIG. 2. Similarly, the first fixed magnets 194 are adjacent in sequence. The first coils 184 correspond respectively to adjacent positions of the first fixed magnets 194.

Two coils 184 and 186 and three fixed magnets 194 and 196 are configured on a single side of the solid lens assembly 160, so that when the coils are driven, enough thrust can be generated to move the solid lens assembly 160 along the solid lens optical axis AXₛ (to overcome an elastic force of the elastic member set 170). In addition, the thrust generated by the coil set 182 and the fixed magnet set 190 is sufficient to continuously push the operating member 142 when the solid lens assembly 160 abuts against the operating member 142, so as to change the radius of curvature of the liquid lens 140 and satisfy the requirements of an object in infinite and short-focus applications.

In some embodiments, two first coils 184 are connected in series, and two second coils 186 are connected in series. The driving assembly 180 further includes a driving circuit 192. The driving circuit 192 electrically connects each of the first coils 184 to each of the second coils 186. The driving circuit 192 is externally controlled to selectively drive the coil set 182 to adjust a focal length of the focusing lens assembly 100. In some embodiments, a sensitivity of the coil set 182 is in a range of 7 μm/mA to 12 μm/mA, and a current outputted from the driving circuit 192 to the coil set 182 is in a range of 15 mA to 90 mA.

Refer to FIG. 2 again. The driving assembly 180 further includes two yoke elements 188a and 188b. The yoke elements 188a and 188b are located on an other side of the first fixed magnet 194 and the second fixed magnet 196 opposite the first coil 184 and the second coil 186 to increase a magnetic field strength of the fixed magnet set 190. In some embodiments, the yoke elements 188a and 188b are yoke iron sheets that cover an outer side of the fixed magnet set 190 (that is, the other side opposite the coil set 182).

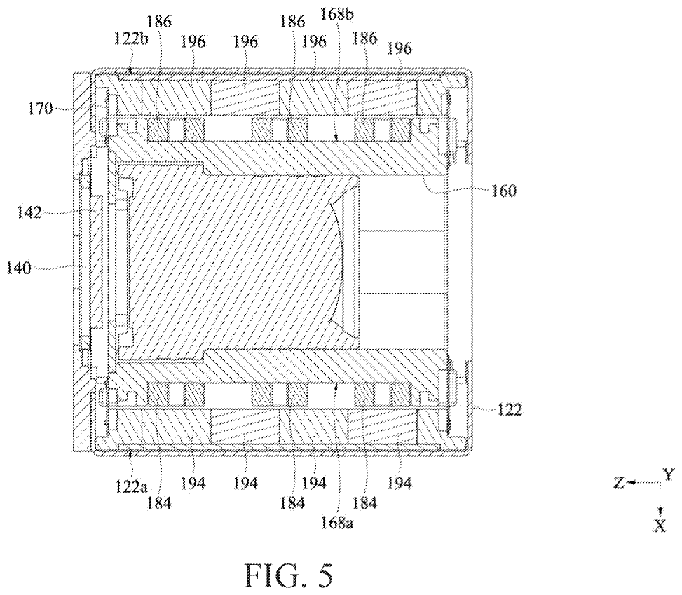

Refer to FIG. 5. FIG. 5 is a schematic plan view of some embodiments of a driving assembly. The perspective of FIG. 5 is the perspective of a top view of FIG. 4. In some embodiments, the driving assembly 180 includes a coil set 182 and a fixed magnet set 190. The coil set 182 includes three first coils 184 and three second coils 186. The fixed magnet set 190 includes four first fixed magnets 194 and four second fixed magnets 196. Each of the first coils 184 is fixed to a first side 168a of the solid lens assembly 160. Each of the second coils 186 is fixed to a second side 168b of the solid lens assembly 160. Each of the first fixed magnets 194 is fixed to a first side 122a of the housing 120. Each of the second fixed magnets 196 is fixed to a second side 122b of the housing 120. The first coils 184 correspond to the first fixed magnets 194. The second coils 186 correspond to the second fixed magnets 196. To be specific, as described above, the center of one first coil 184 or one second coil 186 is roughly aligned with the adjacent position of the corresponding two first fixed magnets 194 or two second fixed magnets 196. The first coils 184 are connected in series in sequence. The second coils 186 are connected in series in sequence. The first coils 184 and the second coils 186 connected in series are electrically connected to the driving circuit 192.

Therefore, in the embodiment of the focusing lens assembly 100 shown in FIG. 5, by increasing quantities of the first coils 184, the second coils 186, the first fixed magnets 194, and the second fixed magnets 196, the force to push the solid lens assembly 160 when the driving assembly 180 is driven may be increased.

It may be learned from the foregoing description that the thrust generated when the driving assembly 180 is driven may be adjusted by using the above different technical means, and the design of a magnitude of the thrust is related to the elastic force of the elastic member set 170, a weight of the solid lens assembly 160, and the force required to push the operating member 142 of the liquid lens 140. That is to say, the required driving assembly 180 may be designed based on the elastic force of the elastic member set 170, the weight of the solid lens assembly 160, and the force required to push the operating member 142 of the liquid lens 140, for example but not limited to the quantities of the first coils 184, the second coils 186, the first fixed magnets 194, and the second fixed magnets 196, the magnetic field strength of the first fixed magnet 194 and the second fixed magnet 196, the sensitivities of the first coil 184 and the second coil 186, and the driving current.

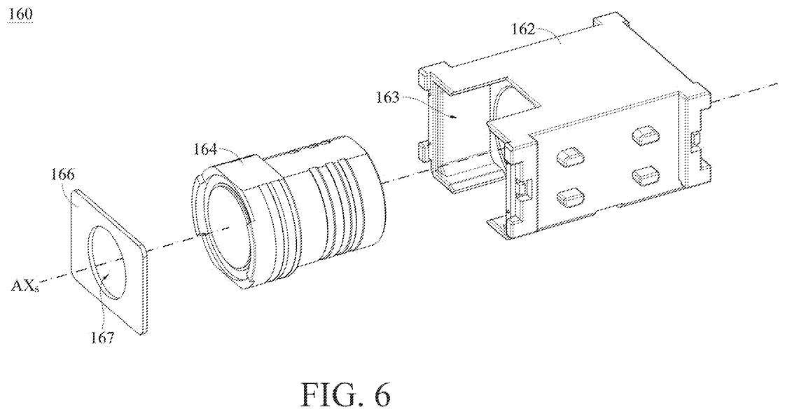

Refer to FIG. 6. FIG. 6 is a three-dimensional exploded view of an embodiment of a solid lens assembly. In some embodiments, a solid lens assembly 160 includes a carrier 162, a plurality of lenses 164, and a cap 166. The carrier 162 is provided with a channel 163, and the plurality of lenses 164 are fixed to the channel 163. A driving assembly 180 drives the carrier 162 to move along a solid lens optical axis AXₛ to selectively enable the cap 166 to abut against an operating member 142. Specifically, when a coil set 182 of the driving assembly 180 is driven, the coil set 182 interacts with the fixed magnet set 190 to enable the carrier 162 to move along the solid lens optical axis AXₛ to selectively enable the cap 166 to abut against the operating member 142. The carrier 162 is accommodated in an accommodating space 126 of a housing 120. The channel 163 corresponds to the accommodating space 126. The plurality of lenses 164 are fixed in the channel 163 on an inner side of the carrier 162. An imaging light ray enters from a light incidence port 128 of the housing 120, passes through the channel 163 and extends through the plurality of lenses 164, and then is emitted from a light emergence port 129 of the housing 120. The plurality of lenses 164 in the drawing are schematically drawn as a whole of these lenses 164. In fact, these lenses 164 are separate lenses and fixed in the carrier 162. 2, 3, 4, or more lenses 164 may be arranged, which depends on the design requirements.

The cap 166 of the embodiment of FIG. 6 is provided with a light-transmitting hole 167, and the channel 163 is a through channel. Centers of the light-transmitting hole 167, the channel 163, and the accommodating space 126 correspond to each other, so that the imaging light ray can extend through the solid lens assembly 160 and reach an image sensor 310 located behind a focusing lens assembly 100 (detailed later). In some embodiments, the cap 166 does not have a light-transmitting hole 167, but a material of the cap 166 is transparent, such as transparent glass. In this way, the cap 166 can not only let the imaging light ray pass through, but also achieve the function of abutting against the operating member 142.

Refer to FIG. 4 and FIG. 5 together. In some embodiments, a liquid lens 140 further includes a lens mount 148, a first film 144, a second film 146, and a fluid 145. The lens mount 148 is provided with a through hole 149. The first film 144 and the second film 146 are fixed to the lens mount 148 and cover the through hole 149. Specifically, the through hole 149 has two openings in the lens mount 148, and the first film 144 and the second film 146 cover the two openings of the through hole 149. The fluid 145 is accommodated between the first film 144 and the second film 146 in a closed space formed by the through hole 149. The operating member 142 is connected to a surface of the second film 146 facing away from the fluid 145. To be specific, the operating member 142 is connected to a surface of the second film 146 oriented in a-Z direction. Materials of the first film 144, the second film 146, and the fluid 145 may be transparent materials. In some embodiments, a material of the operating member 142 is a transparent material, for example but not limited to transparent glass. In this way, the imaging light ray may extend through the first film 144, the fluid 145, the second film 146, and the operating member 142 in sequence and enter the solid lens assembly 160.

In some embodiments, the operating member 142 contacts, is bonded to, or is adhered to a surface of the second film 146 oriented in the −Z direction. In this way, the function of abutment by the solid lens assembly 160 may be achieved.

In some embodiments, the material of the operating member 142 is transparent glass, and the cap 166 is provided with the light-transmitting hole 167, that is, the embodiment shown in FIG. 2. In this embodiment, the light-transmitting hole 167 of the cap 166 should be smaller than that of the operating member 142, so that when the solid lens assembly 160 is driven to move toward a +Z direction, the cap 166 may abut against the operating member 142 to achieve the effect of changing a radius of curvature of the liquid lens 140.

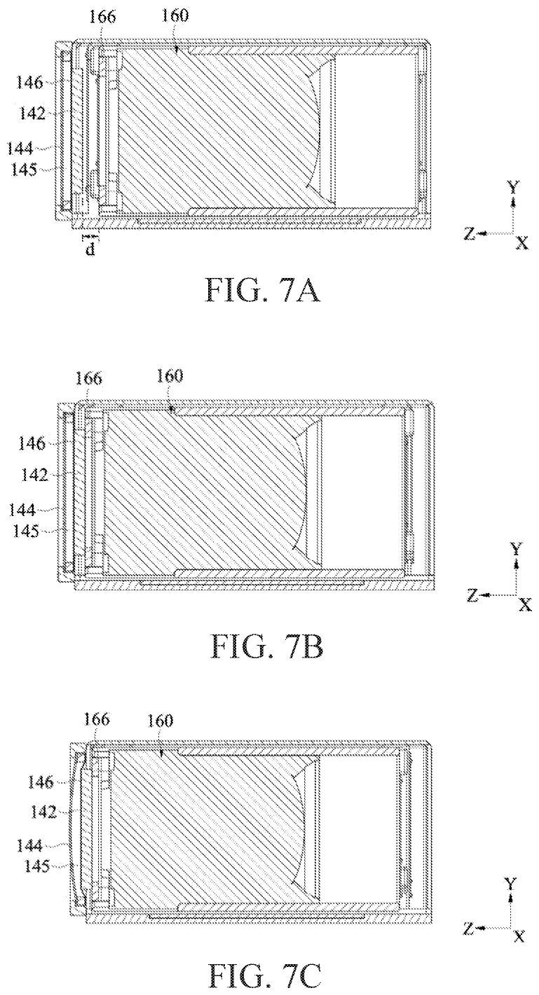

Refer to FIG. 7A, FIG. 7B, and FIG. 7C together. FIG. 7A, FIG. 7B, and FIG. 7C are schematic diagrams showing that a driving assembly 180 drives a solid lens assembly 160 to move along a solid lens optical axis AXₛ. A first film 144 and a second film 146 are elastic. When an operating member 142 is pushed against the cap 166 (as shown in FIG. 7C), the second film 146 moves to a +Z axis to squeeze the fluid 145, so that the first film 144 to protrude in a +Z direction, thereby changing a shape of the first film 144 and further changing a radius of curvature of a liquid lens. FIG. 7A shows a state in which the driving assembly 180 drives the solid lens assembly 160 to move toward the −Z axis. It may be seen from the figure that a distance d between the cap 166 of the solid lens assembly 160 and the operating member 142 is larger than the distance d in FIG. 3. This shows that a focal length of the focusing lens assembly 100 in FIG. 3 is different from that in FIG. 7A. Similarly, FIG. 7B shows a state in which the driving assembly 180 drives the solid lens assembly 160 to move toward the +Z axis, so that the cap 166 contacts the operating member 142. In this case, since the cap 166 only contacts and does not push against the operating member 142, the first film 144 is maintained in a curved shape in an initial state. Next, when the driving assembly 180 continues to drive the solid lens assembly 160 to move toward the +Z axis, the first film 144 starts to protrude outward in the +Z direction, so that the curved shape thereof changes and the focal length changes, thereby achieving a short focal (near focal) length of the focusing lens assembly 100.

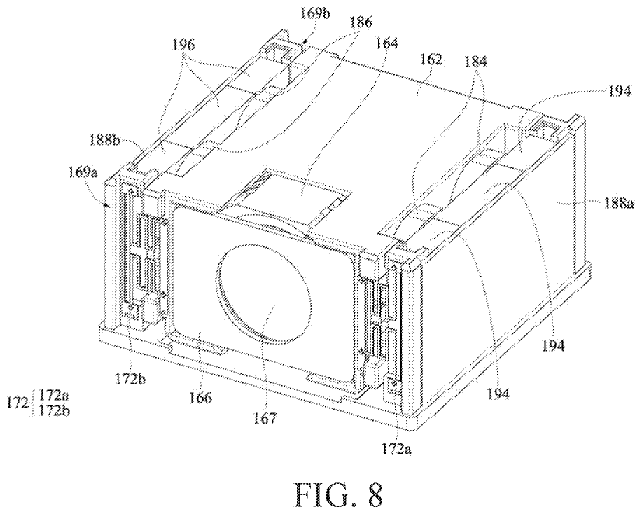

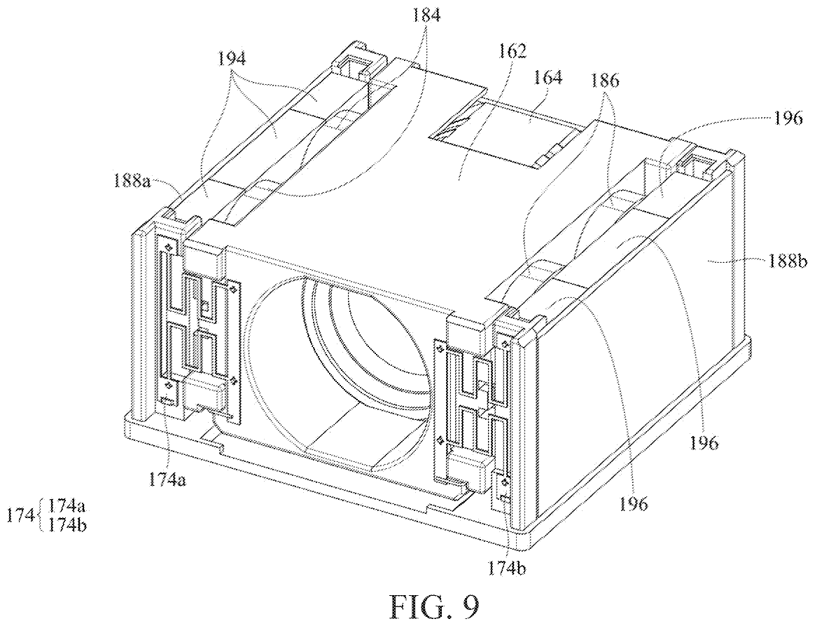

Refer to FIG. 2, FIG. 8, and FIG. 9 again. FIG. 8 is a three-dimensional view of an embodiment of a focusing lens assembly without an upper housing 122 and a liquid lens 140 in FIG. 1. FIG. 9 is a three-dimensional view of FIG. 8 from another perspective. An elastic member set 170 includes a front elastic member 172 and a rear elastic member 174. A position of a solid lens assembly 160 close to a light incidence port 128 of a housing 120 is a front end 169a (that is, a +Z direction). An end of the solid lens assembly 160 opposite the front end 169a is a rear end 169b (that is, in a −Z direction, a position close to a light emergence port 129 of the housing is the rear end 169b). The front elastic member 172 is connected between the front end 169a and the housing 120. The rear elastic member 174 is connected between the rear end 169b and the housing 120. In this way, the elastic member set 170 can suspend the solid lens assembly 160 in an accommodating space 126.

Specifically, the front elastic member 172 includes two front elastic pieces 172a and 172b. The two front elastic pieces 172a and 172b are connected between the front end 169a and the housing 120. The rear elastic member 174 includes two rear elastic pieces 174a and 174b. The two rear elastic pieces 174a and 174b are connected between the rear end 169b and the housing 120. It may be seen from the figure that the front elastic piece 172a is connected between the front end 169a of the carrier 162 (that is, a position facing the liquid lens 140) and a first side 122a of the upper housing 122, and the front elastic piece 172b is connected between the front end 169a of the carrier 162 and a second side 122b of the upper housing 122. Similarly, the rear elastic piece 174a is connected between the rear end 169b (that is, a position oriented in the −Z direction) of the carrier 162 and the first side 122a of the upper housing 122, and the rear elastic piece 174b is connected between the rear end 169b of the carrier 162 and the second side 122b of the upper housing 122.

In some embodiments, the front elastic member 172 and the rear elastic member 174 are respectively single-piece elastic pieces. To be specific, the two front elastic pieces 172a and 172b are actually connected and are the same elastic piece, while the two rear elastic pieces 174a and 174b are actually connected and are the same elastic piece, which may also achieve the purpose of suspending the solid lens assembly 160 in the accommodating space 126. In the embodiment where the front elastic member 172 and the rear elastic member 174 are respectively single-piece elastic pieces, the front elastic member 172 and the rear elastic member 174 need to avoid a region through which an imaging light ray extends (for example, avoid a through hole 149 of a lens mount 148 and a light-transmitting hole 167 of a cap 166).

In the foregoing embodiment, the solid lens assembly 160 of the focusing lens assembly 100 is maintained at a distance d from the liquid lens 140 in a normal state (that is, a driving assembly 180 is not driven). The distance may be a predetermined distance, and a magnitude of the distance depends on the design requirement. The predetermined distance may be adjusted through appropriate design of the elastic force (a suspension force) of the elastic member set 170 and a weight of the solid lens assembly 160. However, a normal relationship between the solid lens assembly 160 and the liquid lens 140 is not limited thereto. In some embodiments, the solid lens assembly 160 may normally contact the operating member 142 of the liquid lens 140 (for example, as shown in FIG. 7B), or the solid lens assembly 160 may normally have a preforce (force) to continuously abut against the operating member 142 of the liquid lens 140.

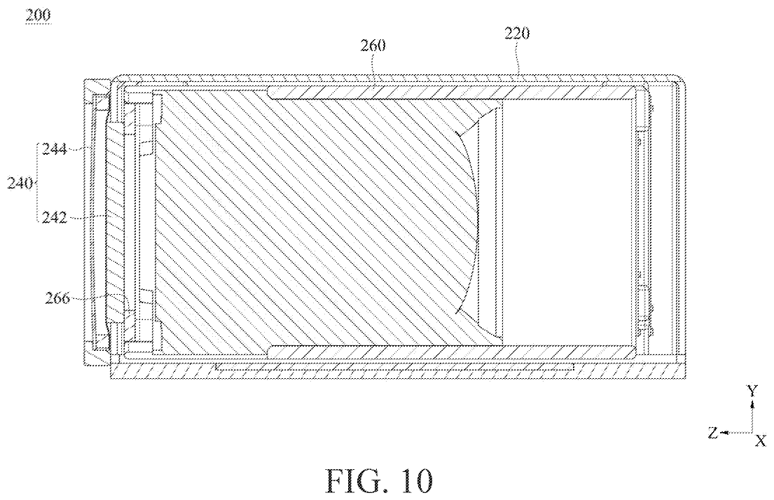

Refer to FIG. 10. FIG. 10 is a cross-sectional view of some embodiments of a focusing lens assembly. A cross-sectional position in FIG. 10 is the same as that in FIG. 3. In this embodiment, a liquid lens 240 of a focusing lens assembly 200 is fixed to a housing 220, and a solid lens assembly 260 is suspended in the housing 220. The solid lens assembly 260 normally has a preforce to push the solid lens assembly 260 toward the liquid lens 240 (that is, a cap 266 of the solid lens assembly 260 normally pushes against an operating member 242 of the liquid lens 240) due to an elastic member set (not shown in the figure, which is similar to the elastic member set 170 in FIG. 2). The normal abutting state is shown in FIG. 10. After the operating member 242 is pushed, a first film 244 slightly protrudes (in a +Z direction). When the focusing lens assembly 200 is in use (for example but not limited to the driving assembly is powered on), the driving assembly (not shown in the figure, which is similar to the driving assembly 180 in FIG. 2) pushes the solid lens assembly 260 to move slightly in a −Z direction, so that a predetermined distance is defined between the solid lens assembly 260 and the liquid lens 240. However, when a control device wants to control the driving assembly to enable the focusing lens assembly 200 to have a short focal length, the control device controls the driving assembly to enable the solid lens assembly 260 move in the +Z direction and enable the solid lens assembly 260 to contact or abut against the operating member 242 based on a demand for the short focal length. In this embodiment, since the elastic member set provides a preforce to enable the solid lens assembly 260 to normally abut against the liquid lens 240, when the coil set of the driving assembly (which is similar to the coil set 182 in FIG. 2, and therefore not shown) is driven to abut against the liquid lens 240, thrust required for the coil set is less than that required for the coil set 182 in FIG. 3. In this way, a thrust specification of the driving assembly configured in the focusing lens assembly 200 of the embodiment of FIG. 10 may be smaller than that of the driving assembly 180 configured in the focusing lens assembly 100 of the embodiment of FIG. 3.

A few manners are provided to enable an elastic member set 170 to generate the foregoing preforce. In a first manner, fixing positions for both ends of the front elastic member 172 of the elastic member set 170 and fixing positions for both ends of the rear elastic member 174 of the elastic member set may be designed to have a height difference. Specifically, a height difference exists between a position where the housing is configured to fix one end of the front elastic member 172 and a position where the solid lens assembly 160, 260 is configured to fix an other end of the front elastic member 172. Similarly, a height difference exists between a position where the housing is configured to fix one end of the rear elastic member 174 and a position where the solid lens assembly 160, 260 is configured to fix an other end of the rear elastic member 174. When the elastic member set 170 is fitted between the solid lens assembly 160, 260 and the housing 120, 220, the solid lens assembly 160, 260 may be enabled to always abut against the operating member 142, 242 of the liquid lens 140, 240.

In a second manner, a height difference exists between both ends of the front elastic member 172 and between both ends of the rear elastic member 174 in a normal state, and the position where the housing is configured to fix the front elastic member set is approximately flush with the position where the solid lens assembly 160, 260 is configured to fix the elastic member set. In this way, when the elastic member set 170 is fitted between the solid lens assembly 160, 260 and the housing 120, 220, the solid lens assembly 160, 260 may be enabled to always abut against the operating member 142, 242 of the liquid lens 140, 240.

Refer to FIG. 2 again. The focusing lens assembly 100 further includes a position sensing component 130. The position sensing component 130 includes a Hall magnet 132 and a Hall sensor 134. The Hall magnet is fixed to the solid lens assembly 160, and the Hall sensor 134 is fixed to the lower housing 124. In this way, when the solid lens assembly 160 is driven, a controller can obtain a position of the solid lens assembly 160 through the Hall sensor 134 and learn a focal length corresponding to the solid lens assembly.

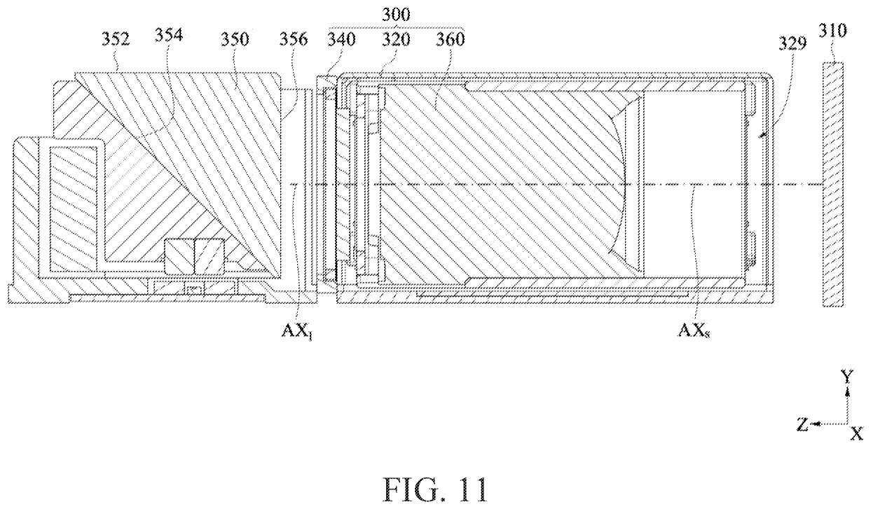

Refer to FIG. 11. FIG. 11 is a cross-sectional view of some embodiments of a periscopic image capturing device. The periscopic image capturing device includes an optical redirecting component 350, a focusing lens assembly 300, and an image sensor 310. The optical redirecting component 350 includes an incident surface 352, a reflective surface 354, and an emergent surface 356. An imaging light ray is incident from the incident surface 352 and reflected by the reflective surface 354 and then emitted from the emergent surface 356. The focusing lens assembly 300 includes a housing 320, a liquid lens 340, a solid lens assembly 360, an elastic member set (which is similar to the elastic member set 170 in FIG. 2, and therefore not shown), and a driving assembly (which is similar to the driving assembly 180 in FIG. 2, and therefore not shown).

The structure of the focusing lens assembly 300 is similar to that of the foregoing focusing lens assemblies 100 and 200 in a plurality of embodiments. Therefore, details are not described again. Only a relationship among the focusing lens assembly 300, the optical redirecting component 350, and the image sensor 310 is described below. A liquid lens optical axis AXₗ of the liquid lens 340 and a solid lens optical axis AXₛ of the solid lens assembly 360 correspond to the emergent surface 356. In some embodiments, the liquid lens optical axis AXₗ and the solid lens optical axis AXₛ are substantially perpendicular to the emergent surface 356 and located in a central region of the emergent surface 356. The image sensor 310 is located on an outer side of a light emergence port 329 (that is, in the −Z direction in FIG. 11). The solid lens optical axis AXₛ substantially extends through the central region of a sensing region of the image sensor 310, which means that the solid lens optical axis AXₛ substantially extends through the vicinity of the center of the sensing region of the image sensor 310.

In some embodiments, the periscopic image capturing device further includes an anti-shake component (not shown in the figure). The anti-shake component is configured to drive the image sensor 310 to provide an anti-shake function during photographing.

Based on the above, according to some embodiments, the focusing lens assembly 100, 200, 300 and the periscopic image capturing device with the focusing lens assembly 100, 200, 300 under proper control can achieve a zoom function not only by using the solid lens assembly 160, 260, 360, but also by using the liquid lens 140, 240, 340, and have the long focal length and the short focal length.

What is claimed is:

1. A focusing lens assembly, comprising:
a housing, provided with an accommodating space, wherein the accommodating space forms a light incidence port in the housing;
a liquid lens, covering the light incidence port and comprising an operating member, wherein the liquid lens has a liquid lens optical axis;
a solid lens assembly, located in the accommodating space and having a solid lens optical axis, wherein the liquid lens optical axis substantially coincides with the solid lens optical axis;
an elastic member set, configured to suspend the solid lens assembly in the accommodating space; and
a driving assembly, comprising:
a coil set, fixed to the solid lens assembly; and
a fixed magnet set, fixed to the housing and corresponding to the coil set, wherein
when the coil set is driven, the coil set interacts with the fixed magnet set, so that the solid lens assembly moves along the solid lens optical axis to selectively enable the solid lens assembly to abut against the operating member.

2. The focusing lens assembly according to claim 1, wherein the coil set comprises two first coils and two second coils, the fixed magnet set comprises three first fixed magnets and three second fixed magnets, the first coils are fixed to a first side of the solid lens assembly, the second coils are fixed to a second side of the solid lens assembly, the first fixed magnets are fixed to a first side of the housing, the second fixed magnets are fixed to a second side of the housing, the first coils correspond to the first fixed magnets, and the second coils correspond to the second fixed magnets.

3. The focusing lens assembly according to claim 2, wherein the first fixed magnets are adjacent in sequence, the first coils correspond respectively to adjacent positions of the first fixed magnets, the second fixed magnets are adjacent in sequence, and the second coils correspond respectively to adjacent positions of the second fixed magnets.

4. The focusing lens assembly according to claim 1, wherein the coil set comprises three first coils and three second coils, the fixed magnet set comprises four first fixed magnets and four second fixed magnets, the first coils are fixed to a first side of a carrier of the solid lens assembly, the second coils are fixed to a second side of the carrier, the first fixed magnets are fixed to a first side of the housing, the second fixed magnets are fixed to a second side of the housing, the first fixed magnets are adjacent in sequence, the first coils correspond respectively to adjacent positions of the first fixed magnets, the second fixed magnets are adjacent in sequence, and the second coils correspond respectively to adjacent positions of the second fixed magnets.

5. The focusing lens assembly according to claim 1, wherein the elastic member set normally has a force to enable the solid lens assembly to abut against the operating member.

6. The focusing lens assembly according to claim 1, wherein the elastic member set comprises a front elastic member and a rear elastic member, a position of the solid lens assembly close to the light incidence port of the housing is a front end, an end of the solid lens assembly opposite the front end is a rear end, the front elastic member is connected between the front end and the housing, and the rear elastic member is connected between the rear end and the housing.

7. The focusing lens assembly according to claim 6, wherein the front elastic member comprises two front elastic pieces, the two front elastic pieces are connected between the front end and the housing, the rear elastic member comprises two rear elastic pieces, and the two rear elastic pieces are connected between the rear end and the housing.

8. The focusing lens assembly according to claim 1, wherein the solid lens assembly comprises:
a carrier, provided with a channel;
a plurality of lenses, fixed to the channel; and
a cap, wherein
the driving assembly drives the carrier to move along the solid lens optical axis to selectively enable the cap to abut against the operating member.

9. The focusing lens assembly according to claim 1, wherein the liquid lens further comprises:
a lens mount, provided with a through hole;
a first film;
a second film, wherein the first film and the second film are fixed to the lens mount and cover the through hole; and
a fluid, accommodated among the through hole, the first film, and the second film, wherein
the operating member is connected to an other side of the second film facing away from the fluid.

10. A periscopic image capturing device, comprising:
an optical redirecting component, comprising an incident surface, a reflective surface, and an emergent surface, wherein an imaging light ray is incident from the incident surface and reflected by the reflective surface and then emitted from the emergent surface;
a focusing lens assembly, comprising:
a housing, provided with an accommodating space, wherein the accommodating space forms a light incidence port and a light emergence port in the housing;
a liquid lens, covering the light incidence port and comprising an operating member, wherein the liquid lens corresponds to the emergent surface and has a liquid lens optical axis;
a solid lens assembly, located in the accommodating space and having a solid lens optical axis, wherein the liquid lens optical axis and the solid lens optical axis substantially coincide and are substantially perpendicular to the emergent surface;
an elastic member set, configured to suspend the solid lens assembly in the accommodating space; and
a driving assembly, comprising:
a coil set, fixed to the solid lens assembly; and
a fixed magnet set, fixed to the housing and corresponding to the coil set, wherein
when the coil set is driven, the coil set interacts with the fixed magnet set, so that the solid lens assembly moves along the solid lens optical axis to selectively enable the solid lens assembly to abut against the operating member; and
an image sensor, located on an outer side of the light emergence port, wherein the solid lens optical axis substantially extends through a central region of a sensing region of the image sensor.

11. The periscopic image capturing device according to claim 10, wherein the coil set comprises two first coils and two second coils, the fixed magnet set comprises three first fixed magnets and three second fixed magnets, the first coils are fixed to a first side of a carrier of the solid lens assembly, the second coils are fixed to a second side of the carrier, the first fixed magnets are fixed to a first side of the housing, the second fixed magnets are fixed to a second side of the housing, the first fixed magnets are adjacent in sequence, the first coils correspond respectively to adjacent positions of the first fixed magnets, the second fixed magnets are adjacent in sequence, and the second coils correspond respectively to adjacent positions of the second fixed magnets.

12. The periscopic image capturing device according to claim 10, wherein the elastic member set normally has a force to enable the solid lens assembly to abut against the operating member.

13. The periscopic image capturing device according to claim 10, wherein the elastic member set comprises a front elastic member and a rear elastic member, a position of the solid lens assembly close to the light incidence port of the housing is a front end, a position of the solid lens assembly close to the light emergence port is a rear end, the front elastic member is connected between the front end and the housing, and the rear elastic member is connected between the rear end and the housing.
